(19) United States
(12) Patent Application Publication
(10) Pub. No.: US 2010/0127418 A1
(43) Pub. Date: May 27, 2010

(54) Methods For Continuous Firing Of Shaped Bodies And Roller Hearth Furnaces Therefor

(76) Inventors: Ronald Alan Davidson, Horseheads, NY (US); Gregory Paul Dillon, Horseheads, NY (US); James Gerard Fagan, Painted Post, NY (US); Kishor Purushottam Gadkaree, Big Flats, NY (US)

Correspondence Address: CORNING INCORPORATED, SP-TI-3-1, CORNING, NY, 14831, US

(21) Appl. No.: 12/366,977

(22) Filed: Feb. 6, 2009

Related U.S. Application Data
(60) Provisional application No. 61/117,767, filed on Nov. 25, 2008.

(51) Int. Cl. B29C 71/02

(52) U.S. Cl. 264/85; 425/445

(57) ABSTRACT

The present disclosure relates to methods and apparatuses for continuous firing of shaped bodies in one cycle, in particular a continuous method for heat treatment and/or control oxidation of shaped bodies by passing them through a roller hearth furnace on furnace trays.

### CROSS-REFERENCE TO RELATED APPLICATION

This application claims the benefit of priority to U.S. Provisional Application No. 61/117,767, filed on Nov. 25, 2008.

### DESCRIPTION

The present disclosure relates to methods and apparatuses for continuous firing of shaped bodies, in particular continuous methods for heat treatment and/or controlled oxidation of shaped bodies in one cycle.

### BACKGROUND OF THE INVENTION

Shaped bodies, including high surface area structures, may be used in a variety of applications. Such bodies may be used, for example, as supports for catalysts for carrying out chemical reactions or as sorbents/filters for the capture of particulate, liquid, or gaseous species from fluids such as gas streams and liquid streams. As an example, certain activated carbon bodies, such as honeycombs, may be used as catalyst substrates or for the capture of heavy metals from gas streams. For example, certain ceramic bodies may also be used as catalyst substrates or for the capture of particulates such as soot.

Shaped bodies may be manufactured by first subjecting an unprocessed or “green” shaped body to one or more heat treatments, and/or then subsequently subjecting the treated shaped body to one or more controlled oxidation firings. Providing a substantially uniformly oxidized shaped body with substantially uniform physical strength may be important to long term performance of the shaped body.

The inventors have now discovered methods for continuous firing of shaped bodies, in particular continuous methods for heat treatment and/or controlled oxidation of shaped bodies in one cycle by passing them through a roller hearth furnace on furnace trays. The presently disclosed methods may allow shaped bodies to be economically manufactured in large quantities, with substantially uniform oxidation. In various exemplary embodiments, the shaped body may be a monolithic structure comprising channels or porous networks permitting the flow of process gas through the monolith, for example, but not limited to, honeycomb shaped bodies comprising an inlet end, an outlet end, and a multiplicity of cells extending from one end to the other, wherein the cells are defined by intersecting cell walls. In at least one additional exemplary embodiment, the shaped body is a ceramic, inorganic cement, or carbon-based body, for example a ceramic honeycomb body.

### SUMMARY

In accordance with the detailed description and exemplary embodiments, the present disclosure relates to methods for continuous firing of shaped bodies comprising heat treatment and/or controlled oxidation of shaped bodies by passing them through a furnace, for example a roller hearth furnace, on furnace trays in one continuous cycle. The methods described herein may reduce the numerous firing cycles described above into one combined heat treatment and/or controlled oxidation firing cycle that is carried out in a continuous roller hearth furnace, in certain embodiments. This allows the shaped bodies to be rapidly processed for high volume and efficient manufacturing. In various exemplary embodiments of the present invention, the methods of the present disclosure produce substantially uniformly oxidized shaped bodies.

Additional objects and advantages of the invention are set forth in the following description. Both the foregoing general summary and the following detailed description are exemplary only and are not restrictive of the invention as claimed. Further features and variations may be provided in addition to those set forth in the description. For instance, the present invention includes various combinations and subcombinations of the features disclosed in the detailed description. In addition, it will be noted that the order of the steps presented need not be performed in that order in order to practice the invention.

### BRIEF DESCRIPTION OF THE DRAWINGS

The accompanying drawings, which are incorporated in and constitute part of this specification, are not intended to be restrictive of the invention as claimed, but rather illustrate exemplary embodiments of the invention and, together with the description, serve to explain the principles of the invention.

FIG. 1 is a schematic diagram of a cross-section of an exemplary tray and setter configuration for conveying the shaped bodies through the continuous firing apparatus and method as disclosed herein.

FIG. 2 is a schematic diagram of an exemplary tray and setter configuration for conveying the shaped bodies through the continuous firing apparatus and method as disclosed herein.

FIG. 3 is a schematic diagram of a cross-section of an exemplary recirculation heating zone within the continuous firing apparatus wherein the process gas flows up, as disclosed herein.

FIG. 4 is a schematic diagram of a longitudinal cross-section of two exemplary recirculation heating zones within the continuous firing apparatus wherein the process gas flows up, as disclosed herein.

FIG. 5 is a schematic diagram of a cross-section of an exemplary direct heating zone within the continuous firing apparatus wherein the process gas flows down, as disclosed herein.

FIG. 6 is a schematic diagram of a longitudinal cross-section of exemplary direct heating zones within the continuous firing apparatus wherein the process gas flows up in the first zone and down in the second zone, as disclosed herein.

FIG. 7 is a schematic diagram of an exemplary continuous firing apparatus and method as described herein.

FIG. 8 is a diagram of the time and temperature profile for the method described in FIG. 7, as disclosed herein.

### DETAILED DESCRIPTION OF THE INVENTION

It is to be understood that both the foregoing general description and the following detailed description are exemplary and explanatory only, and are not restrictive of the disclosure, as claimed. Other embodiments of the disclosure will be apparent to those skilled in the art from consideration of the specification and practice of the present disclosure.

The present disclosure relates to methods for continuous firing of shaped bodies, for example continuous methods for heat treatment and/or controlled oxidation of shaped bodies by passing them through a roller hearth furnace on furnace trays in one cycle. The methods comprise, in at least one embodiment, passing the shaped body through one continuous cycle comprising (a) heat treatment of at least one shaped body by heating the at least one shaped body in at least one heating section in an inert atmosphere; (b) controlled oxidation of the at least one shaped body by soaking the at least one shaped body in at least one oxidation gas in at least one second heating section; and (c) cooling the at least one shaped body in at least one cooling section.

As used in the present disclosure, the term “shaped body,” and variations thereof, is intended to include ceramic, inorganic cement, and/or carbon-based bodies. Ceramic bodies include, but are not limited to, those comprised of cordierite and silicon carbide. Inorganic cement bodies include, but are not limited to, those comprised of inorganic materials comprised of an oxide, sulfate, carbonate, or phosphate of a metal, including calcium oxide, calcium aluminate cements, calcium/magnesium sulfate cements, and calcium phosphate. Carbon-based materials include, but are not limited to, synthetic carbon-containing polymeric material (which may be cured or uncured); activated carbon powder; charcoal powder; coal tar pitch; petroleum pitch; wood flour; cellulose and derivatives thereof; natural organic materials, such as wood flour, nut-shell flour; starch; coke; coal; or mixtures thereof. In some embodiments, the carbon-based material comprises a phenolic resin or a resin based on furfuryl alcohol.

As used in the present disclosure, the term “continuous cycle,” and variations thereof, is intended to mean a series of processing steps wherein the shaped body is passed from one step to the next with minimal or no interruption or removal from the system or cycle.

In various exemplary methods of the present disclosure, the at least one shaped body is placed on at least one setter. A “setter” may be an apparatus, such as a slab, on which the shaped body is mounted for firing. The setter may, in one embodiment, be of the same material as the shaped body which is being fired, and may also have holes. The at least one setter may sit upon at least one furnace tray. The at least one furnace tray may contain open areas (holes) under the at least one setter that allow process gases to flow through the at least one setter and the at least one shaped body. The at least one furnace tray, the at least one setter, and the roller hearth furnace walls may be configured in such a way that the majority of the process gases are forced to flow through the at least one shaped body (i.e. through the holes and/or channels) rather than around it. In one exemplary embodiment, the furnace trays may be in contact with one another and the spaces between the trays and the furnace walls may be blocked, for example by air dam plates. This produces high flow rates of the process gases through the shaped bodies, rather than around the shaped bodies and trays, which may greatly enhance the process. This high volume and uniform concentration of process gas may allow rapid processing of the shaped body through a furnace, such as a continuous roller hearth furnace, for high volume manufacturing. This arrangement may be used throughout the length of the furnace. The at least one furnace tray may be conveyed through the roller hearth furnace. In at least one embodiment, the at least one furnace tray is conveyed through the furnace on furnace rolls.

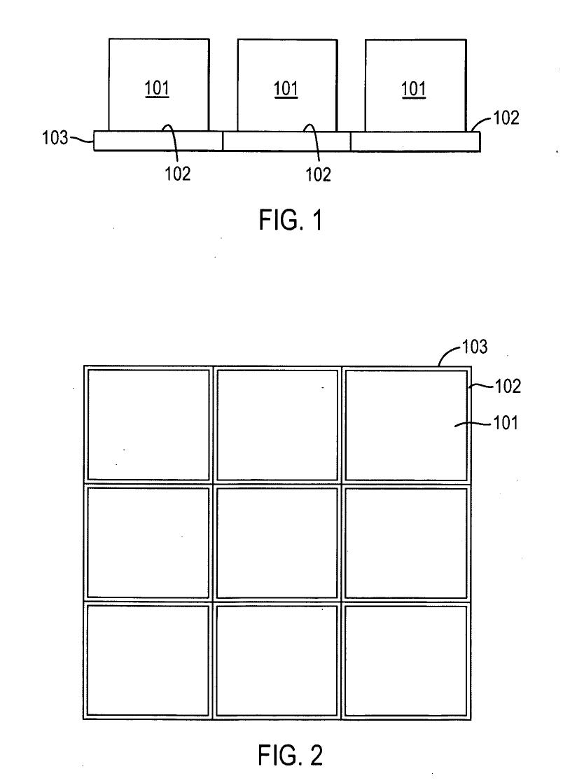

For example, as depicted in FIG. 1, which is an exemplary cross-section of the tray/setter configuration, the at least one shaped body 101 is placed on a setter 102, which sits on a furnace tray 103. FIG. 2, which is also exemplary of the tray/setter configuration, demonstrates that the furnace trays 103 may be in contact with one another. In this particular example, the complete configuration is the width and length of three shaped bodies 101.

As used in the present disclosure, the terms “process gas,” “process gases,” “process atmosphere,” and variations thereof, are intended to mean oxidizing and inert gases, mixtures thereof, and any other gas or atmosphere that may exist in or flow through the furnace and/or furnace sections and/or zones in the presently disclosed methods.

As used in the present disclosure, the term “inert gas,” “inert atmosphere,” and variations thereof, are intended to mean process gases and/or atmospheres comprising at least one inert gas, such as, but not limited to, nitrogen, helium, and argon.

As used in the present disclosure, the term “oxidizing gas,” “oxidizing atmosphere,” “oxidizing agent,” and variations thereof, are intended to mean process gases and/or atmospheres comprising at least one gas containing oxygen species. Examples of oxidizing gases include, but are not limited to carbon dioxide and steam.

As used herein, “substantially uniformly oxidized” and variations thereof means the shaped body is free of cracks and has substantially uniform surface area throughout. Whether the surface area is substantially uniformly oxidized is well within the ability of those skilled in the art to determine.

In at least one exemplary embodiment of the present methods, the at least one shaped body may be conveyed through at least one purge section containing an inert atmosphere, for example before firing. The at least one purge section may prevent air from entering the roller hearth furnace.

In various embodiments, the at least one shaped body may then be conveyed into a series of roller hearth furnace sections. In various exemplary embodiments, the furnace sections of the present disclosure may be used to establish the desired furnace temperature profile for heat treatment and oxidation.

As used herein, the term “zone,” and variations thereof, refers to an area wherein the temperature and/or atmosphere are controlled to establish a given temperature profile and/or atmosphere. In various exemplary embodiments, a zone may have its own process gas source and/or temperature control. The zones can be, for example, either recirculation convection-type heating and/or cooling zones, or direct radiation-type heating and/or cooling zones. The zones can also, for example, contain inert or oxidizing gases.

As used herein, the term “section,” and variations thereof, refers to one or more zones. In various exemplary embodiments, the zones of a section combine to achieve a particular process step. For example, in various exemplary embodiments, several zones may combine to form a heat treatment step, with each zone ramping the temperature by a specified gradient.

In at least one embodiment, the furnace zones are recirculation convection-type heated zones. In at least one further embodiment, the heating in the recirculation convection-type zone may be accomplished at temperatures below 600° C. This may force process gas flow through the shaped bodies to uniformly heat the parts.

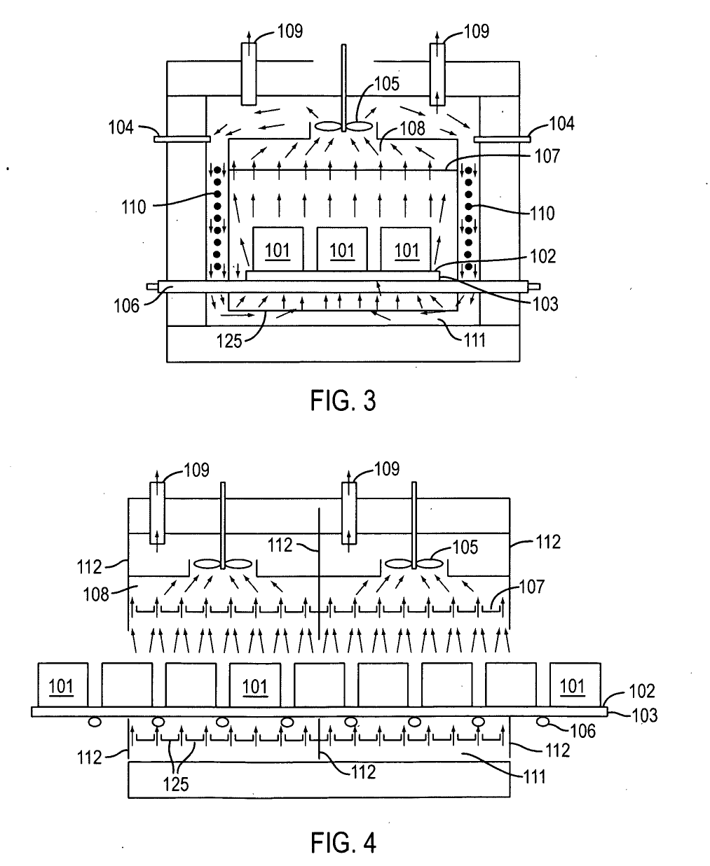

For example, FIG. 3 depicts a schematic diagram of a cross-section of an exemplary recirculation heating zone wherein the process gas flows up. The process gas enters the zone through the input 104 and the recirculation fan 105 forces the process gas to the bottom of the zone and over the heating elements 110. The process gas then passes from the supply plenum 111, through the supply plenum nozzle plate 125, through the rollers 106, trays 103, and setters 102, and enters the shaped bodies 101 from the bottom. The process gas flows up through the shaped bodies 101, through the return plenum nozzle plate 107, and into the return plenum 108. Some of the process gas may exit through the exhaust stack 109, and the remaining process gas is recirculated.

FIG. 4 is a schematic diagram depicting the longitudinal cross-section of two exemplary recirculation heating zones, as depicted in FIG. 3. In addition to numerous features already identified in the description of FIG. 3, FIG. 4 further exhibits top and bottom zone separation plates 112, which may be used to partition one zone from the next.

Using direct radiant heating or direct radiant cooling in the zones in the roller hearth furnace in various exemplary embodiments may allow the process gases to flow through the shaped bodies in one pass-through. According to one embodiment, this option can be utilized if recirculation of “contaminated” process gases is undesirable. Direct radiation heated zones also have the advantage of simple robust construction for high temperature operation. Direct radiant heating does not require the use of metal fans and metal ducts as required for recirculation heating. According to one embodiment, the use of direct radiant heating or direct radiant cooling zones with no metals may prove more economical if corrosion of metals by the process gases from the shaped bodies is too severe.

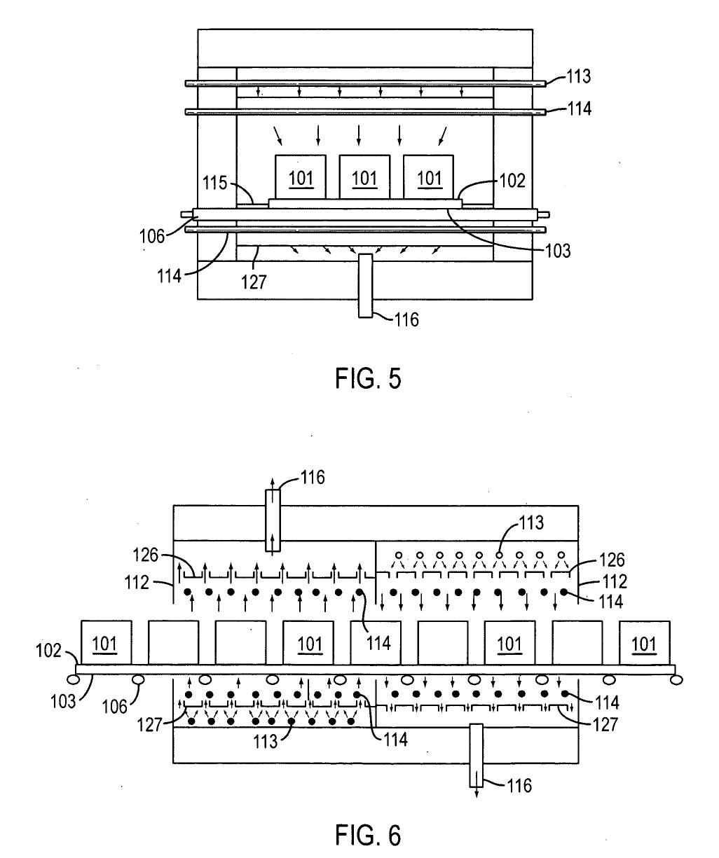

For example, FIG. 5 depicts a schematic diagram of a cross-section of an exemplary direct heating zone within the continuous firing apparatus wherein the process gas flows down. The process gas enters the zone through the inlets 113 and then passes through the upper nozzle plate 126 and over the heating element 114. Due to the presence of the air dam plates 115, the process gas can only flow through the shaped bodies 101. The process gas exits the shaped bodies 101, passes through the setters 102, trays 103, and rollers 106, over a heating element 114, and through lower nozzle plate 127. The process gas exits the zone through the exhaust port 116.

FIG. 6 is a schematic diagram of a longitudinal cross-section of two exemplary direct heating zones, similar to that of FIG. 5, wherein the process gas flows up in the first zone and down in the second zone. In addition to numerous features already identified in the description of FIG. 5, FIG. 6 further exhibits the zone separation plates 112, which partition one zone from the next.

According to one exemplary embodiment, separate sections for heat treating, controlled oxidizing, and/or cooling may be contained in one continuous roller hearth furnace. The sections may, for example, be separated by internal furnace doors and may be comprised of one or more zones. The atmosphere in each section and/or zone may optionally be controlled separately.

Heat treatments, as described herein, may include, for example, carbonization, which is a process that involves the thermal decomposition of the carbonaceous material, in for example a ceramic or carbon-based body, thereby eliminating low molecular weight species (e.g., carbon dioxide, water, and gaseous hydrocarbons) and producing a fixed carbon mass and a rudimentary pore structure in the ceramic or carbon-based body. Traditionally, during carbonization, the shaped body is heated to a high temperature, ranging from, for example, about 600° C. to 1000° C., for a period ranging from several minutes to several hours in an inert atmosphere (e.g., nitrogen, argon, helium, and mixtures thereof). Then, the shaped body is cooled and removed from the furnace. The process may be repeated one or more times.

In addition, or alternatively, the shaped body may undergo a firing effecting controlled oxidation, referred to herein as “controlled oxidation,” “control oxidation,” and variations thereof. Controlled oxidation may include, for example, activation processes. The process of activation may allow the carbon in a ceramic or carbon-based shaped body to form a microcrystalline structure, wherein the carbon has been processed to produce high porosity. Activated carbon may be characterized by a high specific surface area (for example, 300 to 2500 m²/g), which may lead to high adsorptive capability. Traditionally, during controlled oxidation firing, the shaped body, which may be heated in an inert atmosphere (e.g., nitrogen, argon, helium, and mixtures thereof) to a high temperature, ranging from, for example, about 600° C. to 1000° C., prior to oxidation, is “soaked” in an oxidation gas (e.g., carbon dioxide, water, and mixtures thereof) for a few minutes to many hours to oxidize the shaped body. The process may be repeated one or more times.

After optionally conveying the at least one shaped body through the at least one purge section, the shaped body may be heat treated, for example in at least one first heating section. In various embodiments, the shaped body may be conveyed through the at least one first heating section in an inert atmosphere. According to one exemplary embodiment, the inert atmosphere may be nitrogen. The at least one first heating section may be, for example, comprised of at least one zone that is direct radiant heated or recirculation convection heated. If recirculation convection zones are used in various exemplary embodiments, the shaped body may be heated up to 4 times faster than in certain conventional furnaces, with maximum temperature gradients of 5° C. or less within the shaped bodies. The very small temperature gradients may, in various embodiments, inhibit cracking of the shaped bodies.

In various exemplary embodiments, the heat treatment may comprise passing the shaped body through at least two heating sections, wherein the first heating section is comprised of at least one zone for heating the shaped body at a selected temperature, and the second heating section is comprised of at least one zone for holding the shaped body at the selected temperature.

In one exemplary embodiment of the disclosure, the shaped body may be conveyed through heating zones wherein the temperature is ramped to a temperature ranging from 500° C. to 1000° C., for example a temperature ranging from 600° C. to 900° C., in the at least one first heating section.

After heating, the at least one shaped body may, in various embodiments, be conveyed through a second heating section, wherein the shaped body may be held at a specific temperature or temperature range in an inert atmosphere. In one embodiment, the atmosphere is nitrogen. This second heating section may, for example, be comprised of at least one zone that is direct radiant heated or recirculation convection heated.

In one exemplary embodiment, the shaped body may be maintained at a temperature ranging from 500° C. to 1000° C., for example a temperature ranging from 600° C. to 900° C., in the heating section.

According to one exemplary embodiment, the shaped body may be held in the heating section, for example, for a period ranging from a few minutes to several hours.

After heat treating, the at least one shaped body may optionally be conveyed through at least one purge section. In one exemplary embodiment, the at least one purge section may transition the process atmosphere from nitrogen to carbon dioxide.

After the optional purge, the shaped body may, in one exemplary embodiment, be conveyed through at least one second heating section, wherein the shaped body may be oxidized by soaking in at least one oxidizing gas at a high temperature. In one embodiment, the at least one oxidizing gas is carbon dioxide, and in another it is a carbon dioxide combined with nitrogen. The at least one second heating section can be comprised of at least one zone which is, for example, direct radiant heated or recirculation convection heated.

In one exemplary embodiment, the shaped body is maintained at a temperature ranging from 500° C. to 1000° C., for example a temperature ranging from 600° C. to 900° C., in the at least one second heating section.

In one embodiment, the at least one second heating section may use recirculation fans to push the at least one oxidizing gas through the shaped body one or more times before the at least one oxidizing gas exits the furnace. Oxidizing gas flow rates through the shaped body using recirculation can be, for example, up to fifty times higher than that known for certain conventional single process furnaces. The high flow rates may provide a uniform concentration of the at least one oxidizing gas. The combination of high flow rates and uniform concentration may, in some embodiments, result in a much faster and more uniform oxidation process.

In another exemplary embodiment, the at least one second heating section comprises two or more heating zones, independently chosen from direct radiant-type heating and recirculation-type heating zones, that alternate the direction of the at least one oxidizing gas flow from up-to-down and down-to-up in alternating zones.

Heating of the shaped bodies as described herein may occur at any temperature that is sufficient to produce the desired product. The appropriate temperature for obtaining a product with desired properties is well within the knowledge of those skilled in the art to determine. For example, in one embodiment, the shaped body is heated at a maintained temperature ranging from 500° C. to 1000° C., such as, for example, a temperature ranging from 600° C. to 900° C., in any of the zones.

After the oxidation soak, the at least one shaped body is optionally conveyed through at least one purge section. In one exemplary embodiment, the at least one purge section transitions the atmosphere from carbon dioxide to nitrogen.

After the optional purge is complete, the shaped body may be conveyed through at least one cooling section. The at least one cooling section can be comprised of at least one direct radiant cooled or recirculation convection type zone and may be an inert atmosphere. In at least one exemplary embodiment, the inert atmosphere is nitrogen. In another embodiment, radiant type cooling is used at high temperatures. In yet another exemplary embodiment, recirculation type cooling with high flow rates of process gases through the parts may achieve fast and uniform cooling at lower temperatures (e.g., less than 600° C.).

After cooling is complete, the at least one shaped body may optionally be conveyed through at least one purge section at the exit of the roller hearth. The optional purge section prevents air from entering the roller hearth furnace. The shaped bodies may then be conveyed from the optional purge section onto a discharge table at the exit end of the roller hearth furnace.

The shaped body may be further cooled after exiting the roller hearth furnace. In various exemplary embodiments, the shaped body is further cooled in the open air by forced air cooling.

In at least one exemplary embodiment of the invention, methods are disclosed for firing shaped bodies comprising passing at least one shaped body through one continuous cycle, wherein the continuous cycle comprises (a) heat treatment of at least one shaped body in at least one first heating section in an inert atmosphere, (b) controlled oxidation of the at least one shaped body by soaking the at least one shaped body in at least one oxidizing gas in at least one second heating section, and (c) optionally cooling the shaped body. In at least one further exemplary embodiment, the heat treatment comprises passing the shaped body through at least two heating sections, one heating section wherein the temperature is ramped and a second heating section wherein the shaped body is held at a specific temperature or temperature range.

In at least one further exemplary embodiment of the invention, methods are disclosed for firing ceramic bodies comprising passing at least one ceramic body through one continuous cycle, wherein the continuous cycle comprises (a) heat treatment of at least one ceramic body in at least one first heating section in an inert atmosphere, (b) controlled oxidation of the at least one ceramic body by soaking the at least one ceramic body in at least one oxidizing gas in at least one second heating section, and (c) optionally cooling the ceramic body. In at least one further exemplary embodiment, the heat treatment step is carbonization, and the controlled oxidation step is activation. In at least one further exemplary embodiment, the heat treatment comprises passing the ceramic body through at least two heating sections, one heating section wherein the temperature is ramped and a second heating section wherein the shaped body is held at a specific temperature or temperature range.

In at least one additional exemplary embodiment, the methods comprise heat treatment and/or controlled oxidation of at least one honeycomb shaped body, wherein the process gas flows through the multiplicity of cells or channels of the honeycomb body from the inlet end to the outlet end.

Roller hearth furnaces for continuous firing of shaped bodies are also disclosed, for example in various embodiments having at least one first heating section for heat treatment of at least one shaped body in an inert gas, at least one second heating section for soaking the at least one shaped body in at least one oxidizing gas, and optionally at least one cooling section. In at least one embodiment, conveyance through the heating and cooling sections comprises one continuous cycle.

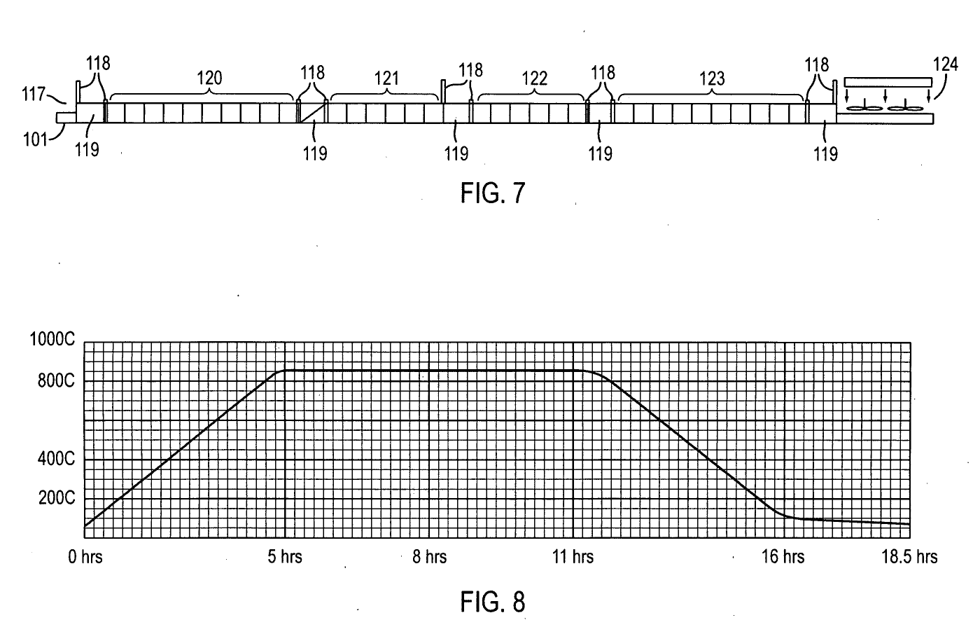

For example, FIG. 7 is a schematic diagram of an exemplary continuous firing apparatus and method. As depicted in FIG. 7, the shaped bodies move from air atmosphere 117, through a door 118, and into a purge section 119. The shaped bodies then pass through another door 118, into a heating section for heat treatment 120, comprised of ten zones for heating the shaped body in a nitrogen atmosphere. The shaped body is then conveyed through another door 118, into another purge section 119, and then through another door 118 to a second heating section 121. The second heating section 121, comprised of six zones for further heat treatment, holds the shaped body at a specified temperature. The shaped body is then conveyed through another door 118, into another purge section 119, and then through another door 118 to a third heating section 122 for controlled oxidation. The third heating section 122 has six zones for soaking the shaped body in an oxidizing gas. The shaped body is then conveyed through another door 118, into another purge section 119, and then through another door 118 to a cooling section 123. Finally, after cooling, the shaped body is removed from the roller hearth furnace by passing through a door 118, a purge section 119, and another door 118. Then the shaped body is cooled in an open air section 124 by forced air cooling.

FIG. 8 is the time and temperature profile for the firing cycle of FIG. 7.

The methods of the present disclosure may be performed in vertical, horizontal, or diagonal direction, or any combination thereof, in various embodiments.

In at least one exemplary embodiment of the present disclosure, a production furnace may contain zones that are any appropriate length, for example, 5 feet long, and the furnace may have an appropriate overall length, for example, of 240 feet.

Unless otherwise indicated, all numbers used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein the use of “the,” “a,” or “an” means “at least one,” and should not be limited to “only one” unless explicitly indicated to the contrary.

Other embodiments of the invention will be apparent to those skilled in the art from consideration of the specification and practice of the invention disclosed herein. It is intended that the specification and examples be considered as exemplary only, with a true scope and spirit of the invention being indicated by the claims.

### EXAMPLE

The following example is not intended to be limiting of the invention as claimed.

Shaped bodies are set on setters in 30″×30″ furnace trays. The bodies are conveyed on trays through the roller hearth in single file at a speed of 5 feet/hour and spend half an hour in each zone.

The furnace contains zones that are 2.5 feet long and has an overall length of 120 feet. Each furnace zone can be either recirculation-type (using up flow or down flow) or direct heated-type (using up flow or down flow). Bidirectional flow may also be used and can be achieved by alternating up-flow zones and down-flow zones.

The purge sections of the furnace hold one tray at a time.

In the following sequence of operations, the tray is continuously conveyed through a furnace as depicted in FIG. 7.

The tray is transported on rollers into the entrance purge section in an air atmosphere with the outer door open and the inner door closed. The outer door is then closed, and the atmosphere is changed from air atmosphere to the same atmosphere as used in the first heating section, which is an inert atmosphere. The inner door is then opened, and the tray is transported into the first heating section, which is comprised of ten heating zones.

The tray is transported through the ten zones of the first heating section at a rate of 5 feet/hour. The zones ramp the temperature from room temperature to 850° C. in 5 hours.

The tray is transported to a second purge section, where the atmosphere in the purge section is set to be the same atmosphere as used in the first heating section with both doors closed. The entry door to the purge section is opened, and the tray is transported from the first heating section into the purge section. Both doors are closed and the atmosphere in the purge section is changed from the atmosphere used in the first heating section to the atmosphere as used in the second heating section, which is an inert atmosphere. The exit door to the purge section is opened, and the tray is transported from the purge section into the second heating section. The exit door on the purge section is closed.

The second heating section is comprised of six zones, wherein the temperature is held at 850° C. for 3 hours. The tray is transported through the second heating section at a rate of 5 feet/hour.

The atmosphere in the next purge section is set to be the same atmosphere as used in the second heating section or hold zones with both doors closed. The entry door to the purge section is opened, and the tray is transported from the second heating section into the purge section. Both doors of the purge section are closed, and the atmosphere in the purge section is changed from the atmosphere used in the second heating section to the atmosphere as used in the next or third heating section. The exit door to purge section is opened, and the tray is transported from the purge section into the third heating section. The exit door on the purge section is closed.

The third heating section is comprised of six zones, wherein the temperature is held at 850° C. for 3 hours in an oxidizing atmosphere. The tray is transported through the third heating section at a rate of 5 feet/hour.

The atmosphere in the next purge section is set to be the same atmosphere as used in the third heating section or oxidizing zones with both doors closed. The entry door to the purge section is opened, and the tray is transported from the third heating section into the purge section. Both doors of the purge section are closed, and the atmosphere in the purge section is changed from the atmosphere used in the third heating section to the atmosphere used in the next section or cooling section. The exit door to purge section is opened, and the tray is transported from the purge section into the cooling section. The exit door on the purge section is closed.

The cooling section is comprised of ten zones, wherein the temperature is cooled from 850° C. to 100° C. in 5 hours. The tray is transported through the cooling section at a rate of 5 feet/hour.

The atmosphere in the next purge section is set to be the same atmosphere used in the cooling section with both doors closed. The entry door to the purge section is opened, and the tray is transported from the cooling section into the purge section. Both doors of the purge section are closed, and the atmosphere in the purge section is changed from the atmosphere used in the cooling section to the air atmosphere. The exit door to purge section is opened, and the tray is transported from the purge section into the forced air cooling section. The exit door on the purge section is closed.

What is claimed:

1. A method for firing shaped bodies comprising passing at least one shaped body through one continuous cycle comprising:
heat treating at least one shaped body by heating the at least one shaped body in at least one first heating section in an inert atmosphere; and
control oxidizing the at least one shaped body by soaking the at least one shaped body in at least one second heating section in at least one oxidizing gas.

2. The method of claim 1, wherein the shaped body is a ceramic, inorganic cement, or carbon-based shaped body.

3. The method of claim 1, wherein, prior to firing, the at least one shaped body is placed on at least one setter and a furnace tray having holes.

4. The method of claim 1, wherein the at least one shaped body is conveyed through at least one purge section before firing.

5. The method of claim 1, wherein the at least one shaped body is heated in the at least one first heating section to a temperature ranging from 600° C. to 900° C., in a nitrogen atmosphere.

6. The method of claim 1, wherein heat treating comprises heating the at least one shaped body in two or more heating sections, wherein one heating section heats the at least one shaped body by passing the shaped body through at least one zone ramping the temperature to a temperature ranging from 600° C. to 900° C. and a second heating section holds the at least one shaped body at a heating section temperature ranging from 600° C. to 900° C.

7. The method of claim 1, wherein the at least one shaped body is conveyed through at least one purge section after heat treating.

8. The method of claim 1, wherein the at least one oxidizing gas in the at least one second heating section is carbon dioxide.

9. The method of claim 1, wherein the at least one second heating section is maintained at a temperature ranging from 600° C. to 900° C.

10. The method of claim 1, wherein the heating sections are comprised of zones, wherein the heating method in each zone is independently chosen from recirculation convection-type heating and direct radiation-type heating.

11. The method of claim 1, wherein the at least one heating section comprises at least two zones, wherein the heating method in each of the at least two zones is independently chosen from recirculation convection-type heating and direct radiation-type heating.

12. The method of claim 11, wherein the at least two zones alternate the direction of the at least one inert and/or oxidizing gas flow from up-to-down and down-to-up in alternating zones.

13. The method of claim 1, wherein the at least one shaped body is conveyed through at least one purge section after control oxidizing.

14. The method of claim 1, wherein the at least one shaped body is conveyed through at least one cooling section after control oxidizing the at least one shaped body.

15. The method of claim 1, wherein the at least one shaped body passes through at least one purge section before entry to and after exiting each heating section.

16. A method for firing of shaped bodies comprising passing at least one shaped body through one continuous cycle comprising:
conveying the at least one shaped body through at least one first purge section;
heat treating at least one shaped body by heating the at least one shaped body in at least one first heating section in at least one inert atmosphere;
conveying the at least one shaped body through at least one second purge section;
controlled oxidizing the at least one shaped body by soaking the at least one shaped body in at least one oxidizing gas in at least one second heating section;
conveying the at least one shaped body through at least one third purge section;
cooling the at least one shaped body in at least one cooling section; and
conveying the at least one shaped body through at least one fourth purge section.

17. The method of claim 16, wherein heat treating the at least one shaped body comprises heating the at least one shaped body in at least two heating sections, wherein one heating section heats the at least one shaped body by passing the shaped body through at least one zone ramping the temperature to a selected temperature, and at least one heating section holds the shaped body at the selected temperature.

18. The method of claim 16, wherein the at least one shaped body is conveyed through at least one purge section between the at least two heating sections.

19. The method of claim 16, wherein the at least one shaped body is a ceramic, inorganic cement, or carbon-based shaped body

20. A roller hearth furnace for continuous firing of shaped bodies comprising:
at least one first heating section for heat treating at least one shaped body in at least one inert gas; and
at least one second heating section for controlled oxidation of the at least one shaped body in at least one oxidizing gas;
wherein conveying the shaped bodies through the heating sections comprises one continuous cycle.

21. The roller hearth furnace of claim 20, wherein the shaped bodies are ceramic, inorganic cement, or carbon-based shaped bodies.
